(19) United States
(12) Patent Application Publication
(10) Pub. No.: US 2025/0299271 A1
(43) Pub. Date: Sep. 25, 2025

(54) METHOD FOR GENERATING OPERATION SCHEDULING SCHEME OF HYDROGEN-PHOTOVOLTAIC-STORAGE-CHARGING INTEGRATED ENERGY STATION

(71) Applicant: STATE GRID NANJING POWER SUPPLY COMPANY, Nanjing City (CN)

(72) Inventors: Dong Xu ZHOU, Nanjing City (CN); Can Zhang, Nanjing City (CN); Wei Gu, Nanjing City (CN); Lin Qing Yang, Nanjing City (CN); Guang Sheng Pan, Nanjing City (CN); Jing Ya Li, Nanjing City (CN); Yu Kuan Ji, Nanjing City (CN); Peng Chen, Nanjing City (CN); Shuo Han, Nanjing City (CN); Yu Yang Wang, Nanjing City (CN)

(73) Assignee: STATE GRID NANJING POWER SUPPLY COMPANY, Nanjing City (CN)

(21) Appl. No.: 19/008,913

(22) Filed: Jan. 3, 2025

(30) Foreign Application Priority Data
Mar. 20, 2024 (CN) 2024103184176

(51) Int. Cl. G06Q 50/06; G06F 17/18; G06Q 10/0631

(52) U.S. Cl. CPC G06Q 50/06; G06F 17/18; G06Q 10/06314

(57) ABSTRACT

A method for generating an operation scheduling scheme of a hydrogen-photovoltaic-storage-charging integrated energy station includes the following steps: setting operating parameters of a hydrogen-photovoltaic-storage-charging integrated energy station; establishing an operation scheduling model of the hydrogen-photovoltaic-storage-charging integrated energy station according to the operating parameters; and finally, iteratively solving the operation scheduling model of the hydrogen-photovoltaic-storage-charging integrated energy station by means of an improved grey wolf optimization algorithm to obtain individual position with a maximum predation benefit in a current wolf population, and outputting the individual position as an optimal scheduling scheme of the hydrogen-photovoltaic-storage-charging integrated energy station. The method stablishes a novel operation scheduling model under the condition that the correlation between multiple types of energy in the hydrogen-photovoltaic-storage-charging integrated energy station and uncertain factors in operation of the hydrogen-photovoltaic-storage-charging integrated energy station are taken into account.

### BACKGROUND OF THE INVENTION

### 1. Technical Field

The invention particularly relates to a method for generating an operation scheduling scheme of a hydrogen-photovoltaic-storage-charging integrated energy station, and belongs to the technical field of generation of operation scheduling schemes for energy stations.

### 2. Description of Related Art

A hydrogen-photovoltaic-storage-charging integrated energy station can be regarded as a small microgrid formed by a power supply and distribution system, an energy storage system, a photovoltaic power generation system, a hydrogen power generation system and a charging system. In such a microgrid, the energy storage system, the photovoltaic power generation system and the hydrogen power generation system work together to supply power to charging piles within a period of high electricity demand; and within a period of low electricity demand, redundant power of the photovoltaic power generation system and the hydrogen power generation system is stored in the energy storage system or sold to a power grid to obtain extra earnings. The key of the hydrogen-photovoltaic-storage-charging integrated energy station lies in unified management and scheduling of photovoltaics, hydrogen energy, energy storage and vehicle charging in the station and intelligent scheduling of photovoltaics, hydrogen energy, energy storage and ordered charging of new energy vehicles according to the real-time weather, electricity price and state of charge (SOC) of batteries of the new energy vehicles to quickly generate an optical configuration scheduling of the hydrogen-photovoltaic-storage-charging integrated energy station under the current electricity demand. Because of the interaction between hydrogen energy, solar energy and electric energy of the hydrogen-photovoltaic-storage-charging integrated energy station and various uncertain factors such as fluctuations of the demand of new energy vehicles and fluctuations of distributed photovoltaic output in operation of the hydrogen-photovoltaic-storage-charging integrated energy station, operation scheduling of the hydrogen-photovoltaic-storage-charging integrated energy station is a random, nonlinear, multi-stage and mixed integer programming complex problem, and it is difficult to quickly obtain an operation scheduling scheme under current constraints.

In the prior art, intelligent algorithms such as the particle swarm algorithm, the genetic algorithm and the grey wolf optimization algorithm or data-driven algorithms such as reinforcement learning and deep learning are often used to solve a scheduling objective function of the hydrogen-photovoltaic-storage-charging integrated energy station under certain constrains to obtain an optimal operation scheduling scheme. However, all these algorithms solve the scheduling problem by iterative searching for an optimal strategy in a large strategy space, and the iterative search has the problem of low search efficiency and running speed.

### BRIEF SUMMARY OF THE INVENTION

The technical issue to be settled by the invention is how to quickly obtain an optimal operation scheduling scheme of a hydrogen-photovoltaic-storage-charging integrated energy station.

The technical solution provided by the invention is as follows: a method for generating an operation scheduling scheme of a hydrogen-photovoltaic-storage-charging integrated energy station comprises the following steps:

Step 1: setting a number N of charging piles, a maximum charge power P of the charging piles, a rated capacity κ^{cap} of hydrogen energy, a maximum charge-discharge power h^{cap}, charge efficiency η^{c}, discharge efficiency η^{dc}, a time of use of the charging piles and required charge energy Eₙᵤₘⁱ of a hydrogen-photovoltaic-storage-charging integrated energy station, wherein i indicates a serial number of each charging pile, T_{num,s}ⁱ and T_{num,e}ⁱ indicate a start time of num^{th} use of an i^{th} charging pile and an end time of the num^{th} use of the i^{th} charging pile, and Eₙᵤₘⁱ indicates the charge energy required for the num^{th} use of the i^{th} charging pile;

Step 2: establishing an operation scheduling model of the hydrogen-photovoltaic-storage-charging integrated energy station, wherein operation scheduling model is expressed by formula (1):

$$\{ \begin{matrix}max J = - {\sum }_{t = 1}^{24} {C}_{t} \\ {C}_{t} = \{ \begin{matrix}{ω}_{t} ( {p}_{t} + {h}_{t , c} - {r}_{t} ) , & if {p}_{t} \leq {r}_{t} - {h}_{t , c} \\ {ω}_{t} ( {p}_{t} - {h}_{t , dc} - {r}_{t} ) , & if {p}_{t} \geq {r}_{t} + {h}_{t , dc} \\ 0 , & else\end{matrix} \\ {p}_{t} = {\sum }_{i = 1}^{N} {p}_{t , i} \\ {h}_{t , c} = min \{ {h}^{cap} , ( 1 - {b}_{t} ) {κ}_{e}^{cap} / {η}^{c} \} \\ {h}_{t , dc} = min \{ {h}^{cap} , {b}_{t} {κ}_{e}^{cap} {η}^{dc} \}\end{matrix} , \qquad ( 1 )$$

in formula (1), Cₜ indicates an operating cost of the integrated energy station at a current time, ωₜ indicates a mains electricity price at the current time, pₜ indicates a total charge power of the integrated energy station, rₜ indicates a distributed photovoltaic output at the current time, h_{t,c} and h_{t,dc} respectively indicate a maximum permissible charge power and a maximum permissible discharge power of the hydrogen energy at the current time, and p_{t,i} indicates a charge power of the i^{th} charging pile at the current time;
obtaining constrains of the operation scheduling model of the hydrogen-photovoltaic-storage-charging integrated energy station, wherein the constraints are expressed by formula (2):

$$\{ \begin{matrix}{b}_{t + 1} = \{ \begin{matrix}max \{ {b}_{t} - {h}_{t} / ( {η}^{dc} {κ}_{e}^{cap} ) , 0 \} , & if {h}_{t} \geq 0 \\ min \{ {b}_{t} - {h}_{t} {η}^{c} / {κ}_{e}^{cap} , 1 \} , & if {h}_{t} \leq 0\end{matrix} \\ {h}_{t} = \{ \begin{matrix}- min \{ {r}_{t} - {p}_{t} , {h}_{t , c} \} , & if {r}_{t} \geq {p}_{t} \\ min \{ {p}_{t} - {r}_{t} , {h}_{t , dc} \} , & if {r}_{t} \leq {p}_{t}\end{matrix} \\ {T}_{t + 1}^{i} = \{ \begin{matrix}{T}_{t}^{i} - 1 , & if {L}_{t}^{i} = 1 \\ {τ}_{t + 1}^{i} , & if {L}_{t + 1}^{i} \times ( 1 - {L}_{t}^{i} ) > 0 \\ 0 , & if {L}_{t + 1}^{i} = 0\end{matrix} \\ {E}_{t + 1}^{i} = \{ \begin{matrix}{E}_{t}^{i} - {z}_{t}^{i} P Δ T {ψ}^{c} , & if {L}_{t}^{i} = 1 \\ {η}_{t + 1}^{i} , & if {L}_{t + 1}^{i} \times ( 1 - {L}_{t}^{i} ) > 0 \\ 0 , & if {L}_{t + 1}^{i} = 0\end{matrix} \\ \{ \begin{matrix}0 \leq {p}_{t , i} \leq P \\ {p}_{t , i} = 0 , if {T}_{t}^{i} = 0 or {E}_{t}^{i} = 0\end{matrix}\end{matrix} , \qquad ( 2 )$$

in formula (2), bₜ indicates an energy level of the hydrogen energy at the current time; hₜ indicates an output power of the hydrogen energy at the current time; Tₜⁱ indicates a remaining charge time of the i^{th} charging pile at the current time; Lₜⁱ indicates whether a vehicle is being charged by the i^{th} charging pile at the current time, wherein when Lₜⁱ is 1, it indicates that a vehicle is being charged by the i^{th} charging pile at the current time, and if Lₜⁱ is 0, it indicates that no vehicle is being charged by the i^{th} charging pile at the current time; τₜ₊₁ⁱ indicates a retention time for charging of an electric vehicle that arrives at a charging station and uses the i^{th} charging pile at a next time; Eₜⁱ indicates remaining charge energy of the i^{th} charging pile at the current time; τₜ₊₁ⁱ indicates charge energy required by the electric vehicle that arrives at the charging station and uses the i^{th} charging pile at the next time; and

Step 3: iteratively solving the operation scheduling model of the hydrogen-photovoltaic-storage-charging integrated energy station by means of an improved grey wolf optimization algorithm to obtain an individual position with a maximum predation benefit in a current wolf population, and outputting the individual position as an optimal scheduling scheme of the hydrogen-photovoltaic-storage-charging integrated energy station, wherein a specific process of iteratively solving the operation scheduling model of the hydrogen-photovoltaic-storage-charging integrated energy station comprises:

Step 3.1: optimizing and improving an initial wolf population of the grey wolf optimization algorithm to obtain an ultimate initial wolf population, which specifically comprises the following steps:

Step 3.1.1: setting a number g of coarse populations and a number k of excellent wolf individuals in the iterative solving process, and initializing an iteration r to satisfy r=1;

Step 3.1.2: representing position information Xⱼ of a j^{th} wolf according to a matrix formed by charge powers of the N charge piles at each time, wherein the position information Xⱼ of the j^{th} wolf is expressed by formula (3):

$${X}_{j} = {[ {p}_{t , i} ]}_{24 \times N} ; \qquad ( 3 )$$

Step 3.1.3: randomly generating an initial wolf population formed by m wolves, randomly generating 24×N values according to a value range of p_{t,i} in formula (2), and substituting the values into formula (3) to obtain position information of one wolf in the initial wolf population; repeating the step until position information of each wolf in the wolf population is generated; collecting the position information of all the wolves in the initial wolf population to form a position information set X of the initial wolf population, wherein the position information set X is expressed by formula (4):

$$X = \{ {X}_{1} , {X}_{2} , … , {X}_{m} \} , \qquad ( 4 )$$

in formula (4), X₁ is first position information of a first wolf in the initial wolf population, X₂ is second position information of a second wolf in the initial wolf population, and Xₘ is m^{th} position information of a m^{th} wolf in the initial wolf population;
Step 3.1.4: substituting the first position information in the position information set X of the initial wolf population into the operation scheduling model of the hydrogen-photovoltaic-storage-charging integrated energy station for calculation, and taking a calculation result as a predation benefit of the first wolf in the initial wolf population; repeating the process until the predation benefit of each wolf in the initial wolf population is obtained; sorting the predation benefits of all the wolves in the initial wolf population in a descending order, and plotting a first predation benefit curve; calculating similarities between the first predation benefit curve and five standard predation benefit curves, and selecting a curve type of the standard predation benefit curve with a maximum similarity as a curve type of the first predation benefit curve; calculating a noise level between the standard predation benefit curve with the maximum similarity and the first predation benefit curve; and

Step 3.1.5: obtaining values of optimized parameters Z₁, Z₂, Z₃ and Z₄ of the initial wolf population according to the curve type and the noise level of the first predation benefit curve obtained in Step 3.1.4, and calculating a size s of the ultimate initial population according to formula (5):

$$s = {e}^{{Z}_{1}} {k}^{{Z}_{2}} {g}^{{Z}_{3}} + {Z}_{4} , \qquad ( 5 )$$

in formula (5), e is a natural base;

Step 3.2: normalizing first three wolves in the ultimate initial wolf population as a α wolf, a β wolf and a δ wolf respectively, and calculating distances from each wolf other than the α wolf, the β wolf and the δ wolf in the ultimate initial wolf population to the α wolf, the β wolf and the δ wolf according to formula (6):

$$\{ \begin{matrix}{D}_{α} ( j ) = \vert {C}_{α} ▯ {X}_{α} ( r ) - {X}_{j} ( r ) \vert \\ {D}_{β} ( j ) = \vert {C}_{β} ▯ {X}_{β} ( r ) - {X}_{j} ( r ) \vert \\ {D}_{δ} ( j ) = \vert {C}_{δ} ▯ {X}_{δ} ( r ) - {X}_{j} ( r ) \vert \\ {C}_{α} = 2 {U}_{α , 1} \\ {C}_{β} = 2 {U}_{β , 1} \\ {C}_{δ} = 2 {U}_{δ , 1}\end{matrix} , \qquad ( 6 )$$

in formula (6), j is a natural number which is greater than or equal to 4 and less than or equal to s; D_{α}(j) is a distance from the j^{th} wolf in the ultimate initial wolf population to the α wolf; D_{β} (j) is a distance from the j^{th} wolf in the ultimate initial wolf population to the β wolf; D_{δ}(j) is a distance from the j^{th} wolf in the ultimate initial wolf population to the δ wolf; X_{α}(r), X_{β}(r) and X_{δ}(r) are respectively position information of the α wolf, the β wolf and the δ wolf; Xⱼ(r) is position information of the j^{th} wolf; C_{α}, C_{β} and C_{δ} are distance coefficients of the α wolf, the β wolf and the δ wolf respectively; U_{α,1}, U_{β,1} and U_{δ,1} are random numbers which are randomly generated within [0, 1] and distributed uniformly;

Step 3.3: updating position information, in a next iteration, of each wolf other than the α wolf, the β wolf and the δ wolf in the ultimate initial wolf population according to formula (7):

$$\{ \begin{matrix}{X}_{j} ( r + 1 ) = \frac{{X}_{α} ( r + 1 ) + {X}_{β} ( r + 1 ) + {X}_{δ} ( r + 1 )}{3} \\ {X}_{α} ( r + 1 ) = {X}_{α} ( r ) - {A}_{α} {D}_{α} ( j ) \\ {X}_{β} ( r + 1 ) = {X}_{β} ( r ) - {A}_{β} {D}_{β} ( j ) \\ {X}_{δ} ( r + 1 ) = {X}_{δ} ( r ) - {A}_{δ} {D}_{δ} ( j ) \\ {A}_{α} = 2 a {U}_{α , 2} - a \\ {A}_{β} = 2 a {U}_{β , 2} - a \\ {A}_{δ} = 2 a {U}_{δ , 2} - a \\ a = 2 - 2 r / R\end{matrix} , \qquad ( 7 )$$

in formula (7), Xⱼ(r+1) is the position information of the j^{th} wolf in the next iteration; X_{α}(r+1), X_{β}(r+1) and X_{δ}(r+1) are respectively the position information of the α wolf, the β wolf and the δ wolf in the next iteration; A_{α}, A_{β} and A_{δ} are respectively distance update coefficients of the α wolf, the β wolf and the δ wolf; U_{α,2}, U_{β,2} and U_{δ,2} are respectively random numbers that are randomly generated within [0, 1] and distributed uniformly; r is a current iteration; R is a maximum iteration;
after the position information, in the next iteration, of each wolf other than the α wolf, the β wolf and the δ wolf in the initial wolf population is calculated, increasing the current iteration r by 1, and determining whether the current iteration r is greater than or equal to the maximum iteration R; if so, outputting the position information, in the current iteration, of all the wolves in the ultimate initial wolf population; if not, substituting the position information, in the current iteration, of all the wolves in the ultimate initial wolf population into Step 3.2 and Step 3.3 for iterative calculation again until the current iteration r is greater than or equal to the maximum iteration R; and

Step 3.4: sequentially substituting the position information of all the wolves in the ultimate initial wolf population output in Step 3.3 into the operation scheduling model of the hydrogen-photovoltaic-storage-charging integrated energy station for calculation to obtain predation benefits of all the wolves in the ultimate initial wolf population; and the selecting the position information of the wolf with the maximum predation benefit in the ultimate initial wolf population as the optimal operation scheduling scheme of the hydrogen-photovoltaic-storage-charging integrated energy station.

The invention has the following beneficial effects: 1, the method provided by the invention stablishes a novel operation scheduling model of the hydrogen-photovoltaic-storage-charging integrated energy station under the condition that the correlation between multiple types of energy in the hydrogen-photovoltaic-storage-charging integrated energy station and uncertain factors in operation of the hydrogen-photovoltaic-storage-charging integrated energy station are taken into account; because both the correlation between multiple types of energy in the hydrogen-photovoltaic-storage-charging integrated energy station and uncertain factors in operation of the hydrogen-photovoltaic-storage-charging integrated energy station are taken into account, the method has a better effect when applied to an optimal solution algorithm. 2. The invention adopts the improved grey wolf optimization algorithm to generate a specifical initial wolf population rather than a randomly generated initial wolf population adopted by an existing gray wolf optimization algorithm, such that an initial wolf population with a better size is obtained, the problem of low iterative solving speed caused by an excessively large initial wolf population of the existing grey wolf optimization algorithm is solved, and the operation scheduling scheme of the hydrogen-photovoltaic-storage-charging integrated energy station can be generated quickly.

### BRIEF DESCRIPTION OF THE SEVERAL VIEWS OF THE DRAWINGS

FIG. 1 is a flow diagram of a method for generating an operation scheduling scheme of a hydrogen-photovoltaic-storage-charging integrated energy station according to the invention.

FIG. 2 is a convergence graph of an operation result obtained by the method provided by the invention according to one specific embodiment.

FIG. 3 is a convergence graph of an operation result obtained by an existing operation scheduling method.

### DETAILED DESCRIPTION OF THE INVENTION

A method for generating an operation scheduling scheme of a hydrogen-photovoltaic-storage-charging integrated energy station provided by the invention is further described below in conjunction with accompanying drawings and specific embodiments.

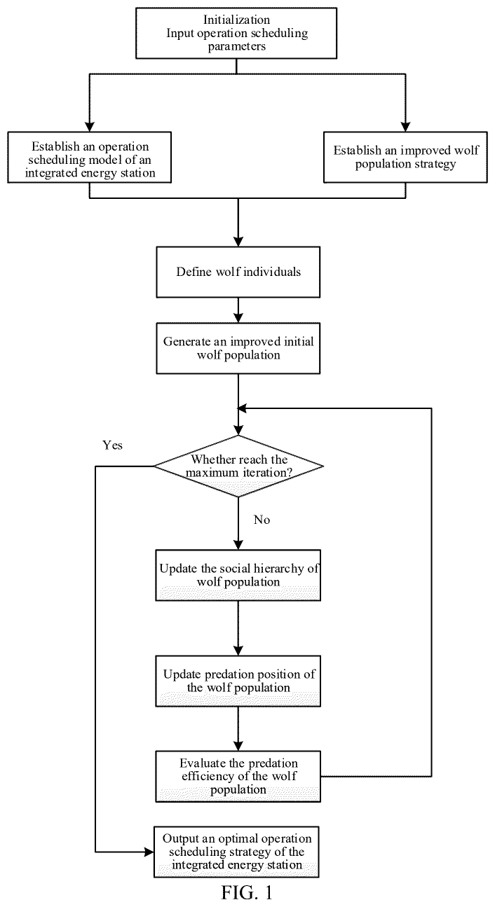

A method for generating an operation scheduling scheme of a hydrogen-photovoltaic-storage-charging integrated energy station, as shown in FIG. 1, comprises the following steps:

Step 1: setting a number N of charging piles, a maximum charge power P of the charging piles, a rated capacity κₑ^{cap} of hydrogen energy, a maximum charge-discharge power h^{cap}, charge efficiency η^{c}, discharge efficiency η^{dc}, a time of use [T_{num,s}ⁱ,T_{num,e}ⁱ] of the charging piles and required charge energy Eₙᵤₘⁱ of a hydrogen-photovoltaic-storage-charging integrated energy station, wherein i indicates a serial number of each charging pile, T_{num,s}ⁱ and T_{num,e}ⁱ indicate a start time of num^{th} use of an i^{th} charging pile and an end time of the num^{th} use of the i^{th} charging pile, and Eₙᵤₘⁱ indicates the charge energy required for the num^{th} use of the i^{th} charging pile;

Step 2: establishing an operation scheduling model of the hydrogen-photovoltaic-storage-charging integrated energy station, wherein operation scheduling model is expressed by formula (1):

$$\{ \begin{matrix}max J = - {{\sum }_{t = 1}}^{24} {C}_{t} \\ {C}_{t} = \{ \begin{matrix}\begin{matrix}{ω}_{t} ( {p}_{t} - {h}_{t , c} - {r}_{t} ) , if {p}_{t} \leq {r}_{t} - {h}_{t , c} \\ {ω}_{t} ( {p}_{t} - {h}_{t , d c} - {r}_{t} ) , if {p}_{t} \geq {r}_{t} + {h}_{t , d c}\end{matrix} \\ 0 , else\end{matrix} \\ {p}_{t} = {\sum }_{i = 1}^{N} {p}_{t , i} \\ {h}_{t , c} = min \{ {h}^{c a p} , ( 1 - {b}_{t} ) {κ}_{e}^{c a p} / {η}^{c} \} \\ {h}_{t , d c} = min \{ {h}^{c a p} , {b}_{t} {κ}_{e}^{c a p} {η}^{d c} \}\end{matrix} , \qquad ( 1 )$$

in formula (1), Cₜ indicates an operating cost of the integrated energy station at a C current time, ωₜ indicates a mains electricity price at the current time, pₜ indicates a total charge power of the integrated energy station, rₜ indicates a distributed photovoltaic output at the current time, h_{t,c} and h_{t,dc} respectively indicate a maximum permissible charge power and a maximum permissible discharge power of the hydrogen energy at the current time, and p_{t,i} indicates a charge power of the i^{th} charging pile at the current time;
obtaining constrains of the operation scheduling model of the hydrogen-photovoltaic-storage-charging integrated energy station, wherein the constraints are expressed by formula (2):

$$\{ \begin{matrix}{b}_{t + 1} = \{ \begin{matrix}max \{ {b}_{t} - {h}_{t} / ( {η}^{d c} {κ}_{e}^{cap} ) , 0 \} & if {h}_{t} \geq 0 \\ min \{ {b}_{t} - {h}_{t} {η}^{c} / {κ}_{e}^{cap} , 1 \} , & if {h}_{t} \leq 0\end{matrix} \\ {h}_{t} = \{ \begin{matrix}- min \{ {r}_{t} - {p}_{t} , {h}_{t , c} \} , & if {r}_{t} \geq {p}_{t} \\ min \{ {p}_{t} - {r}_{t} , {h}_{t , d c} \} , & if {r}_{t} \leq {p}_{t}\end{matrix} \\ {T}_{t + 1}^{i} = \{ \begin{matrix}{T}_{t}^{i} - 1 , & if {L}_{t}^{i} = 1 \\ {τ}_{t + 1}^{i} , & if {L}_{t + 1}^{i} \times ( 1 - {L}_{t}^{i} ) > 0 \\ 0 , & if {L}_{t + 1}^{i} = 0\end{matrix} \\ {E}_{t + 1}^{i} = \{ \begin{matrix}{E}_{t}^{i} - {z}_{t}^{i} P Δ T {ψ}^{c} , & if {L}_{t}^{i} = 1 \\ {η}_{t + 1}^{i} , & if {L}_{t + 1}^{i} \times ( 1 - {L}_{t}^{i} ) > 0 \\ 0 , & if {L}_{t + 1}^{i} = 0\end{matrix} \\ \{ \begin{matrix}0 \leq {p}_{t , i} \leq P \\ {p}_{t , i} = 0 , if {T}_{t}^{i} = 0 or {E}_{t}^{i} = 0\end{matrix}\end{matrix} , \qquad ( 2 )$$

in formula (2), bₜ indicates an energy level of the hydrogen energy at the current time; hₜ indicates an output power of the hydrogen energy at the current time; Tₜⁱ indicates a remaining charge time of the i^{th} charging pile at the current time; Lₜⁱ indicates whether a vehicle is being charged by the i^{th} charging pile at the current time, wherein when Lₜⁱ is 1, it indicates that a vehicle is being charged by the i^{th} charging pile at the current time, and if Lₜⁱ is 0, it indicates that no vehicle is being charged by the i^{th} charging pile at the current time; τₜ₊₁ⁱ indicates a retention time for charging of an electric vehicle that arrives at a charging station and uses the i^{th} charging pile at a next time; Eₜⁱ indicates remaining charge energy of the i^{th} charging pile at the current time; τₜ₊₁ⁱ indicates charge energy required by the electric vehicle that arrives at the charging station and uses the i^{th} charging pile at the next time; and

Step 3: iteratively solving the operation scheduling model of the hydrogen-photovoltaic-storage-charging integrated energy station by means of an improved grey wolf optimization algorithm to obtain an individual position with a maximum predation benefit in a current wolf population, and outputting the individual position as an optimal scheduling scheme of the hydrogen-photovoltaic-storage-charging integrated energy station, wherein a specific process of iteratively solving the operation scheduling model of the hydrogen-photovoltaic-storage-charging integrated energy station comprises:

Step 3.1: optimizing and improving an initial wolf population of the grey wolf optimization algorithm to obtain an ultimate initial wolf population, which specifically comprises the following steps:

Step 3.1.1: setting a number g of coarse populations and a number k of excellent wolf individuals in the iterative solving process, and initializing an iteration r to satisfy r=1;

Step 3.1.2: representing position information Xⱼ of a j^{th} wolf according to a matrix formed by charge powers of the N charge piles at each time, wherein the position information Xⱼ of the j^{th} wolf is expressed by formula (3):

$${x}_{j} = {[ {p}_{t , i} ]}_{24 \times N} ; \qquad ( 3 )$$

Step 3.1.3: randomly generating an initial wolf population formed by m wolves, randomly generating 24×N values according to a value range of p_{t,i} in formula (2), and substituting the values into formula (3) to obtain position information of one wolf in the initial wolf population; repeating the step until position information of each wolf in the wolf population is generated; collecting the position information of all the wolves in the initial wolf population to form a position information set X of the initial wolf population, wherein the position information set X is expressed by formula (4):

$$X = \{ {X}_{1} , {X}_{2} , … , {X}_{m} \} ; \qquad ( 4 )$$

in formula (4), X₁ is first position information of a first wolf in the initial wolf population, X₂ is second position information of a second wolf in the initial wolf population, and Xₘ is m^{th} position information of a m^{th} wolf in the initial wolf population;

Step 3.1.4: substituting the first position information in the position information set X of the initial wolf population into the operation scheduling model of the hydrogen-photovoltaic-storage-charging integrated energy station for calculation, and taking a calculation result as a predation benefit of the first wolf in the initial wolf population; repeating the process until the predation benefit of each wolf in the initial wolf population is obtained; sorting the predation benefits of all the wolves in the initial wolf population in a descending order, and plotting a first predation benefit curve; calculating similarities between the first predation benefit curve and five standard predation benefit curves, and selecting a curve type of the standard predation benefit curve with a maximum similarity as a curve type of the first predation benefit curve; calculating a noise level between the standard predation benefit curve with the maximum similarity and the first predation benefit curve; and

Step 3.1.5: obtaining values of optimized parameters Z₁, Z₂, Z₃ and Z₄ of the initial wolf population according to the curve type and the noise level of the first predation benefit curve obtained in Step 3.1.4, and calculating a size s of the ultimate initial population according to formula (5):

$$s = {e}^{{Z}_{1}} {k}^{{Z}_{2}} {g}^{{Z}_{3}} + {Z}_{4} ; \qquad ( 5 )$$

in formula (5), e is a natural base;

Step 3.2: normalizing first three wolves in the ultimate initial wolf population as a α wolf, a β wolf and a δ wolf respectively, and calculating distances from each wolf other than the α wolf, the β wolf and the δ wolf in the ultimate initial wolf population to the α wolf, the β wolf and the δ wolf according to formula (6):

$$\{ \begin{matrix}{D}_{α} ( j ) = \vert {C}_{α} ▯ {X}_{α} ( r ) - {X}_{j} ( r ) \vert \\ {D}_{β} ( j ) = \vert {C}_{β} ▯ {X}_{β} ( r ) - {X}_{j} ( r ) \vert \\ {D}_{δ} ( j ) = \vert {C}_{δ} ▯ {X}_{δ} ( r ) - {X}_{j} ( r ) \vert \\ {C}_{α} = 2 {U}_{α , 1} \\ {C}_{β} = 2 {U}_{β , 1} \\ {C}_{δ} = 2 {U}_{δ , 1}\end{matrix} , \qquad ( 6 )$$

in formula (6), j is a natural number which is greater than or equal to 4 and less than or equal to s; D_{α}(j) is a distance from the j^{th} wolf in the ultimate initial wolf population to the α wolf; D_{β}(j) is a distance from the j^{th} wolf in the ultimate initial wolf population to the β wolf; D_{δ}(j) is a distance from the j^{th} wolf in the ultimate initial wolf population to the δ wolf; X_{α}(r), X_{β}(r) and X_{δ}(r) are respectively position information of the α wolf, the β wolf and the δ wolf; x, (r) is position information of the j^{th} wolf; C_{α}, C_{β} and C_{δ} are distance coefficients of the α wolf, the β wolf and the δ wolf respectively; U_{α,1}, U_{β,1} and U_{δ,1} are random numbers which are randomly generated within [0,1] and distributed uniformly;

Step 3.3: updating position information, in a next iteration, of each wolf other than the α wolf, the β wolf and the δ wolf in the ultimate initial wolf population according to formula (7):

$$\{ \begin{matrix}{X}_{j} ( r + 1 ) = \frac{{X}_{α} ( r + 1 ) + {X}_{β} ( r + 1 ) + {X}_{δ} ( r + 1 )}{3} \\ {X}_{α} ( r + 1 ) = {X}_{α} ( r ) - {A}_{α} {D}_{α} ( j ) \\ {X}_{β} ( r + 1 ) = {X}_{β} ( r ) - {A}_{β} {D}_{β} ( j ) \\ {X}_{δ} ( r + 1 ) = {X}_{δ} ( r ) - {A}_{δ} {D}_{δ} ( j ) \\ {A}_{α} = 2 a {U}_{α , 2} - a \\ {A}_{β} = 2 a {U}_{β , 2} - a \\ {A}_{δ} = 2 a {U}_{δ , 2} - a \\ a = 2 - 2 r / R\end{matrix} , \qquad ( 7 )$$

in formula (7), Xⱼ(r+1) is the position information of the j^{th} wolf in the next iteration; X_{α}(r+1), X_{β}(r+1) and X_{δ}(r+1) are respectively the position information of the α wolf, the β wolf and the δ wolf in the next iteration; A_{α}, A_{β} and A_{δ} are respectively distance update coefficients of the α wolf, the β wolf and the δ wolf; U_{α,2}, U_{β,2} and U_{δ,2} are respectively random numbers that are randomly generated within [0, 1] and distributed uniformly; r is a current iteration; R is a maximum iteration;
after the position information, in the next iteration, of each wolf other than the α wolf, the β wolf and the δ wolf in the initial wolf population is calculated, increasing the current iteration r by 1, and determining whether the current iteration r is greater than or equal to the maximum iteration R; if so, outputting the position information, in the current iteration, of all the wolves in the ultimate initial wolf population; if not, substituting the position information, in the current iteration, of all the wolves in the ultimate initial wolf population into Step 3.2 and Step 3.3 for iterative calculation again until the current iteration r is greater than or equal to the maximum iteration R; and
Step 3.4: sequentially substituting the position information of all the wolves in the ultimate initial wolf population output in Step 3.3 into the operation scheduling model of the hydrogen-photovoltaic-storage-charging integrated energy station for calculation to obtain predation benefits of all the wolves in the ultimate initial wolf population; and the selecting the position information of the wolf with the maximum predation benefit in the ultimate initial wolf population as the optimal operation scheduling scheme of the hydrogen-photovoltaic-storage-charging integrated energy station.

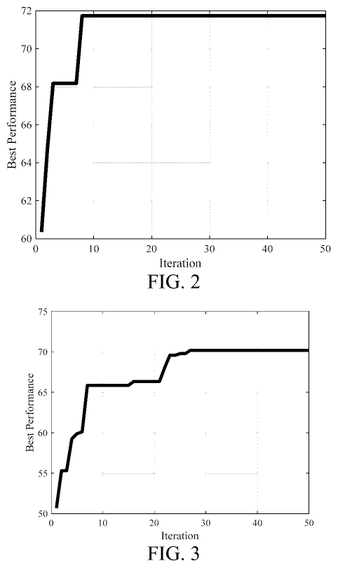

The hardware environment for a test is a CPU Core™ i5-1340P, the memory of which is 16 G. Test parameters are set as follows: N=20, P=3.6 KW, κₑ^{cap}=166.65 kWh, h^{cap}=50 kW, η^{c}=0.82, η^{dc}=0.62, the time of use [T_{num,s}ⁱ,T_{num,e}ⁱ] of the charging pile is, randomly generated within [1,24], Eₙᵤₘⁱ is a random value within [P,5P], R=50, g=20 and k=10. In the test, the method provided by the invention and a classic grey wolf algorithm are compared, as shown in FIG. 2 and FIG. 3, in which the horizontal axis indicates the iteration of wolf populations based on the grey wolf algorithms, and the vertical axis indicates the optimal predation efficiency of the wolf populations under the current iteration. It can be seen from FIGS. 2 and 3 that by adopting the method for generating an operation scheduling scheme of a hydrogen-photovoltaic-storage-charging integrated energy station based on an improved gray wolf algorithm, an optimal solution can be obtained basically after 10 iterations, while when the classic gray wolf optimization algorithm is adopted, an optimal solution is obtained after about 28 iterations. The running time of the method provided by the invention is 58 seconds, while the running time of the classic gray wolf optimization algorithm is 142 seconds, this is mainly because the invention provides an improved gray wolf algorithm, which can improve the quality of the initial wolf population and improve the search efficiency of an optimal operation scheduling strategy.

What is claimed is:

1. A method for generating an operation scheduling scheme of a hydrogen-photovoltaic-storage-charging integrated energy station, comprising the following steps:
Step 1: setting a number N of charging piles, a maximum charge power P of the charging piles, a rated capacity κₑ^{cap} of hydrogen energy, a maximum charge-discharge power h^{cap}, charge efficiency η^{c}, discharge efficiency η^{dc}, a time of use [T_{num,s}ⁱ,T_{num,e}ⁱ] of the charging piles and required charge energy Eₙᵤₘⁱ of a hydrogen-photovoltaic-storage-charging integrated energy station, wherein i indicates a serial number of each charging pile, T_{num,s}ⁱ and T_{num,e}ⁱ indicate a start time of num^{th} use of an i^{th} charging pile and an end time of the num^{th} use of the i^{th} charging pile, and Eₙᵤₘⁱ indicates the charge energy required for the num^{th} use of the i^{th} charging pile;
Step 2: establishing an operation scheduling model of the hydrogen-photovoltaic-storage-charging integrated energy station, wherein operation scheduling model is expressed by formula (1):
$$\{ \begin{matrix}max J = - {{\sum }_{t = 1}}^{24} {C}_{t} \\ {C}_{t} = \{ \begin{matrix}\begin{matrix}{ω}_{t} ( {p}_{t} - {h}_{t , c} - {r}_{t} ) , if {p}_{t} \leq {r}_{t} - {h}_{t , c} \\ {ω}_{t} ( {p}_{t} - {h}_{t , d c} - {r}_{t} ) , if {p}_{t} \geq {r}_{t} + {h}_{t , d c}\end{matrix} \\ 0 , else\end{matrix} \\ {p}_{t} = {\sum }_{i = 1}^{N} {p}_{t , i} \\ {h}_{t , c} = min \{ {h}^{c a p} , ( 1 - {b}_{t} ) {κ}_{e}^{c a p} / {η}^{c} \} \\ {h}_{t , d c} = min \{ {h}^{c a p} , {b}_{t} {κ}_{e}^{c a p} {η}^{d c} \}\end{matrix} , \qquad ( 1 )$$
in formula (1), Cₜ indicates an operating cost of the integrated energy station at a current time, ωₜ indicates a mains electricity price at the current time, pₜ indicates a total charge power of the integrated energy station, rₜ indicates a distributed photovoltaic output at the current time, h_{t,c} and h_{t,dc} respectively indicate a maximum permissible charge power and a maximum permissible discharge power of the hydrogen energy at the current time, and p_{t,i} indicates a charge power of the i^{th} charging pile at the current time;
obtaining constrains of the operation scheduling model of the hydrogen-photovoltaic-storage-charging integrated energy station, wherein the constraints are expressed by formula (2):
$$\{ \begin{matrix}{b}_{t + 1} = \{ \begin{matrix}max \{ {b}_{t} - {h}_{t} / ( {η}^{d c} {κ}_{e}^{cap} ) , 0 \} & if {h}_{t} \geq 0 \\ min \{ {b}_{t} - {h}_{t} {η}^{c} / {κ}_{e}^{cap} , 1 \} , & if {h}_{t} \leq 0\end{matrix} \\ {h}_{t} = \{ \begin{matrix}- min \{ {r}_{t} - {p}_{t} , {h}_{t , c} \} , & if {r}_{t} \geq {p}_{t} \\ min \{ {p}_{t} - {r}_{t} , {h}_{t , d c} \} , & if {r}_{t} \leq {p}_{t}\end{matrix} \\ {T}_{t + 1}^{i} = \{ \begin{matrix}{T}_{t}^{i} - 1 , & if {L}_{t}^{i} = 1 \\ {τ}_{t + 1}^{i} , & if {L}_{t + 1}^{i} \times ( 1 - {L}_{t}^{i} ) > 0 \\ 0 , & if {L}_{t + 1}^{i} = 0\end{matrix} \\ {E}_{t + 1}^{i} = \{ \begin{matrix}{E}_{t}^{i} - {z}_{t}^{i} P Δ T {ψ}^{c} , & if {L}_{t}^{i} = 1 \\ {η}_{t + 1}^{i} , & if {L}_{t + 1}^{i} \times ( 1 - {L}_{t}^{i} ) > 0 \\ 0 , & if {L}_{t + 1}^{i} = 0\end{matrix} \\ \{ \begin{matrix}0 \leq {p}_{t , i} \leq P \\ {p}_{t , i} = 0 , if {T}_{t}^{i} = 0 or {E}_{t}^{i} = 0\end{matrix}\end{matrix} , \qquad ( 2 )$$
in formula (2), bₜ indicates an energy level of the hydrogen energy at the current time; hₜ indicates an output power of the hydrogen energy at the current time; Tₜⁱ indicates a remaining charge time of the i^{th} charging pile at the current time; Lₜⁱ indicates whether a vehicle is being charged by the i^{th} charging pile at the current time, wherein when Lₜⁱ is 1, it indicates that a vehicle is being charged by the i^{th} charging pile at the current time, and if Lₜⁱ is 0, it indicates that no vehicle is being charged by the i^{th} charging pile at the current time; τₜ₊₁ⁱ indicates a retention time for charging of an electric vehicle that arrives at a charging station and uses the i th charging pile at a next time; Eₜⁱ indicates remaining charge energy of the i^{th} charging pile at the current time; τₜ₊₁ⁱ indicates charge energy required by the electric vehicle that arrives at the charging station and uses the i^{th} charging pile at the next time; and
Step 3: iteratively solving the operation scheduling model of the hydrogen-photovoltaic-storage-charging integrated energy station by means of an improved grey wolf optimization algorithm to obtain an individual position with a maximum predation benefit in a current wolf population, and outputting the individual position as an optimal scheduling scheme of the hydrogen-photovoltaic-storage-charging integrated energy station, wherein a specific process of iteratively solving the operation scheduling model of the hydrogen-photovoltaic-storage-charging integrated energy station comprises:
Step 3.1: optimizing and improving an initial wolf population of the grey wolf optimization algorithm to obtain an ultimate initial wolf population, which specifically comprises the following steps:
Step 3.1.1: setting a number g of coarse populations and a number k of excellent wolf individuals in the iterative solving process, and initializing an iteration r to satisfy r=1;
Step 3.1.2: representing position information Xⱼ of a j^{th} wolf according to a matrix formed by charge powers of the N charge piles at each time, wherein the position information Xⱼ of the j^{th} wolf is expressed by formula (3):
$${x}_{j} = {[ {p}_{t , i} ]}_{24 \times N} , \qquad ( 3 )$$
Step 3.1.3: randomly generating an initial wolf population formed by m wolves, randomly generating 24x N values according to a value range of p_{t,i} in formula (2), and substituting the values into formula (3) to obtain position information of one wolf in the initial wolf population;
repeating the step until position information of each wolf in the wolf population is generated;
collecting the position information of all the wolves in the initial wolf population to form a position information set X of the initial wolf population, wherein the position information set X is expressed by formula (4):
$$X = \{ {X}_{1} , {X}_{2} , … , {X}_{m} \} , \qquad ( 4 )$$
in formula (4), X₁ is first position information of a first wolf in the initial wolf population, X₂ is second position information of a second wolf in the initial wolf population, and Xₘ is m^{th} position information of a m^{th} wolf in the initial wolf population;
Step 3.1.4: substituting the first position information in the position information set X of the initial wolf population into the operation scheduling model of the hydrogen-photovoltaic-storage-charging integrated energy station for calculation, and taking a calculation result as a predation benefit of the first wolf in the initial wolf population; repeating the process until the predation benefit of each wolf in the initial wolf population is obtained; sorting the predation benefits of all the wolves in the initial wolf population in a descending order, and plotting a first predation benefit curve; calculating similarities between the first predation benefit curve and five standard predation benefit curves, and selecting a curve type of the standard predation benefit curve with a maximum similarity as a curve type of the first predation benefit curve; calculating a noise level between the standard predation benefit curve with the maximum similarity and the first predation benefit curve; and
Step 3.1.5: obtaining values of optimized parameters Z₁, Z₂, Z₃ and Z₄ of the initial wolf population according to the curve type and the noise level of the first predation benefit curve obtained in Step 3.1.4, and calculating a size s of the ultimate initial population according to formula (5):
$$s = {e}^{{Z}_{1}} {k}^{{Z}_{2}} {g}^{{Z}_{3}} + {Z}_{4} , \qquad ( 5 )$$
in formula (5), e is a natural base;
Step 3.2: normalizing first three wolves in the ultimate initial wolf population as a α wolf, a β wolf and a δ wolf respectively, and calculating distances from each wolf other than the α wolf, the β wolf and the δ wolf in the ultimate initial wolf population to the α wolf, the β wolf and the β wolf according to formula (6):
$$\{ \begin{matrix}{D}_{α} ( j ) = \vert {C}_{α} ▯ {X}_{α} ( r ) - {X}_{j} ( r ) \vert \\ {D}_{β} ( j ) = \vert {C}_{β} ▯ {X}_{β} ( r ) - {X}_{j} ( r ) \vert \\ {D}_{δ} ( j ) = \vert {C}_{δ} ▯ {X}_{δ} ( r ) - {X}_{j} ( r ) \vert \\ {C}_{α} = 2 {U}_{α , 1} \\ {C}_{β} = 2 {U}_{β , 1} \\ {C}_{δ} = 2 {U}_{δ , 1}\end{matrix} , \qquad ( 6 )$$
in formula (6), j is a natural number which is greater than or equal to 4 and less than or equal to s; D_{α}(j) is a distance from the j^{th} wolf in the ultimate initial wolf population to the α wolf; D_{β}(j) is a distance from the j^{th} wolf in the ultimate initial wolf population to the β wolf; D_{δ}(j) is a distance from the j^{th} wolf in the ultimate initial wolf population to the δ wolf; X_{α}(r), X_{β}(r) and X_{δ}(r) are respectively position information of the α wolf, the β wolf and the δ wolf; Xⱼ(r) is position information of the j^{th} wolf; C_{α}, C_{β} and C_{δ} are distance coefficients of the α wolf, the β wolf and the δ wolf respectively; U_{α,1}, U_{β,1} and U_{δ,1} are random numbers which are randomly generated within [0,1] and distributed uniformly;
Step 3.3: updating position information, in a next iteration, of each wolf other than the α wolf, the β wolf and the δ wolf in the ultimate initial wolf population according to formula (7):
$$\{ \begin{matrix}{X}_{j} ( r + 1 ) = \frac{{X}_{α} ( r + 1 ) + {X}_{β} ( r + 1 ) + {X}_{δ} ( r + 1 )}{3} \\ {X}_{α} ( r + 1 ) = {X}_{α} ( r ) - {A}_{α} {D}_{α} ( j ) \\ {X}_{β} ( r + 1 ) = {X}_{β} ( r ) - {A}_{β} {D}_{β} ( j ) \\ {X}_{δ} ( r + 1 ) = {X}_{δ} ( r ) - {A}_{δ} {D}_{δ} ( j ) \\ {A}_{α} = 2 a {U}_{α , 2} - a \\ {A}_{β} = 2 a {U}_{β , 2} - a \\ {A}_{δ} = 2 a {U}_{δ , 2} - a \\ a = 2 - 2 r / R\end{matrix} , \qquad ( 7 )$$
in formula (7), Xⱼ(r+1) is the position information of the j^{th} wolf in the next iteration; X_{α}(r+1), X_{β}(r+1) and X_{δ}(r+1) are respectively the position information of the α wolf, the β wolf and the δ wolf in the next iteration; A_{α}, A_{β} and A_{δ} are respectively distance update coefficients of the α wolf, the β wolf and the δ wolf; U_{α,2}, U_{β,2} and U_{δ,2} are respectively random numbers that are randomly generated within [0, 1] and distributed uniformly; r is a current iteration; R is a maximum iteration;
after the position information, in the next iteration, of each wolf other than the α wolf, the β wolf and the δ wolf in the initial wolf population is calculated, increasing the current iteration r by 1, and determining whether the current iteration r is greater than or equal to the maximum iteration R; if so, outputting the position information, in the current iteration, of all the wolves in the ultimate initial wolf population; if not, substituting the position information, in the current iteration, of all the wolves in the ultimate initial wolf population into Step 3.2 and Step 3.3 for iterative calculation again until the current iteration r is greater than or equal to the maximum iteration R; and
Step 3.4: sequentially substituting the position information of all the wolves in the ultimate initial wolf population output in Step 3.3 into the operation scheduling model of the hydrogen-photovoltaic-storage-charging integrated energy station for calculation to obtain predation benefits of all the wolves in the ultimate initial wolf population; and the selecting the position information of the wolf with the maximum predation benefit in the ultimate initial wolf population as the optimal operation scheduling scheme of the hydrogen-photovoltaic-storage-charging integrated energy station.
